(19) United States
(12) Patent Application Publication
(10) Pub. No.: US 2015/0226671 A1
(43) Pub. Date: Aug. 13, 2015

(54) METHOD FOR DETERMINING ACTIVITY OF NUCLEIC-ACID-REPAIR ENZYME

(71) Applicant: TAIWAN SUGAR CORPORATION, TAINAN CITY (TW)

(72) Inventors: I-JEN HUANG, TAINAN CITY (TW); YU-HSUAN CHEN, TAINAN CITY (TW)

(21) Appl. No.: 14/507,261

(22) Filed: Oct. 6, 2014

(30) Foreign Application Priority Data
Feb. 12, 2014 (TW) 103104533

(51) Int. Cl. G01N 21/64

(52) U.S. Cl. CPC G01N 21/6486; G01N 21/6428; G01N 2021/6432

(57) ABSTRACT

A method for determining the activity of a nucleic-acid-repair enzyme is provided. The method comprises the following steps: (i) providing a double-stranded nucleic acid molecule, which is labeled with a fluorophore and a quencher and has at least one mutated nucleotide in either strand; (ii) mixing the double-stranded nucleic acid molecule, S1 nuclease, and the sample to obtain a mixture; and measuring the fluorescence intensity of the mixture.

This application claims the benefit of Taiwan Patent Application No. 103104533, filed on Feb. 12, 2014, in the Taiwan Intellectual Property Office, the disclosure of which is incorporated herein in its entirety by reference.

### FIELD

The present invention relates to a method for determining the activity of a nucleic-acid-repair enzyme, comprising the use of a double-stranded nucleic acid molecule and S1 nuclease for determining the enzyme activity. In particular, the method of the present invention comprises the use of a double-stranded nucleic acid molecule and S1 nuclease for determining the activity of nucleic-acid-repair enzymes, wherein the double-stranded nucleic acid molecule is labeled with a fluorophore and a quencher and having at least one mutated nucleotide in either strand.

### DESCRIPTION OF THE RELATED ART

A deoxyribonucleic acid (DNA) or ribonucleic acid (RNA) mutation refers to the changes in the DNA base or RNA base in cells that lead to a partial or complete loss of gene activity. In general, damage that leads to nucleic acid mutation can be classified as endogenous and exogenous. Endogenous damage is, for example, caused by reactive oxygen species (ROS) or nucleotide base mismatch; the exogenous damage is, for example, caused by ultra violet, radiant ray, and chemical materials (alkylating agent, ammonia removal agent, etc.).

Examples of a mutated nucleotide include 8-oxoguanine (8-oxoG), which is generated by the oxidation of nucleotide bases; O6-methylguanine, N7-methylguanine, and N3-methyladenine, which are generated by the alkylation of nucleotide bases; abnormal nucleotides, which are generated by the hydrolysis of nucleotide bases that results in depurination or depyrimidination; and a pyrimidine dimmer, which is generated by the abnormal linkage of adjacent pyrimidines. In addition, the mismatch of nucleotide bases also results in the generation of mutated nucleotides. The mismatch of nucleotide bases is caused by the addition of an incorrect nucleotide into the growing strand during nucleic acid replication. Examples of nucleotide base mismatch include a spontaneous mismatch between adenylic acid (A) and uridylic acid (U) occurring during DNA replication, and a dU:dA mismatch that results from the uracil generated by the deamination of a methylated cytosine.

In general, the nucleic-acid-repair enzyme can remove damaged nucleotides in a subject and replace them with correct nucleotides. Based on the mechanisms of action, nucleic-acid-repair enzymes can be classified into nucleotide excision repair (NER) and base excision repair (BER), etc. However, along with the increase in the degree of aging or the incidence of diseases, the activities of nucleic-acid-repair enzymes decrease. For example, 8-oxoguanine glycosylase (OGG1) is the DNA repair enzyme for recognizing the oxidative damage site of 8-oxoG DNA in a subject. Previous studies showed that as OGG1 activity reduces, the repair ability of 8-oxoG in the cell will be reduced or lost. As a result, the risk of the subject of developing cancer (such as lung cancer, esophageal cancer) will increase. In addition, studies showed that the high expression level of OGG1 in embryo tissue, indicated that OGG1 protein can prevent embryo DNA from oxidative damage, and is necessary for the normal development of an embryo (see Dizdaroglu, M. Oxidatively induced DNA damage: mechanisms, repair and disease. Cancer Lett. Review. 2012.:26-47; Karahalil, B. et al., 2002. Base excision repair capacity in mitochondria and nuclei: tissue-specific variation. FASEB J. 14:1895-902 ; and Paz-Elizur, T. et al., 2003. DNA repair activity for oxidative damage and risk of lung cancer. J Natl Cancer Inst. 17:1312-9, which is entirely incorporated hereinto by reference). Therefore, the degree of aging and/or disease incidence can be estimated by measuring the nucleic-acid-repair activity.

A traditional method for measuring the activity of nucleic-acid-repair enzyme is by radioactive labeling. In this method, a radioactive material [γ-32P] is labeled on the 5′ end of a single-stranded nucleotide sequence with damaged nucleotide by using T4 polymerase. The labeled nucleic acid and unlabeled complementary nucleic acid are combined to form a double-stranded nucleic acid and react with a sample comprising a nucleic-acid-repair enzyme. The reaction is then stopped by adding phenol/chloroform or ethanol thereinto. Then, the sample is heated at 90° C. for 5 minutes to unwind the double-stranded nucleic acid, and analyzed by gel electrophoresis. Because [y-32P] is labeled on the nucleic acid, the results are analyzed by the size of the nucleic acid (see Karahalil, B. et al., 2002. Base excision repair capacity in mitochondria and nuclei: tissue-specific variation. FASEB J.14:1895-902; and Paz-Elizur, T. et al., 2003. DNA repair activity for oxidative damage and risk of lung cancer. J Natl Cancer Inst. 17:1312-9, which are entirely incorporated hereinto by reference). However, traditional radioactive labeling is complicated, time consuming, difficult to observe dynamic results and requiring the use of radioactive materials.

In view of the above, the inventors of the present invention developed a platform for determining the activity of a nucleic-acid-repair enzyme by using a double-stranded nucleic acid molecule and S1 nuclease, wherein the double-stranded nucleic acid molecule is labeled with a fluorophore and a quencher. The platform for determining the activity of a nucleic-acid-repair enzyme of the present invention has advantages of being stable, handy, and easy to observe dynamic results, and does not require radioactive materials. It could be used to evaluate the aging degree of a subject and the incidence of diseases in the fields of clinical disease detection or medical cosmetics.

### SUMMARY

An objective of the present invention is to provide a method for determining the activity of a nucleic-acid-repair enzyme in a sample, comprising the following steps: (i) providing a double-stranded nucleic acid molecule, which is labeled with a fluorophore and a quencher and has at least one mutated nucleotide in either strand; (ii) mixing the double-stranded nucleic acid molecule, S1 nuclease, and the sample to obtain a mixture; and measuring the fluorescence intensity of the mixture.

Another objective of the present invention is to provide a kit for determining the activity of a nucleic-acid-repair enzyme, comprising the following: a first part, comprising a double-stranded nucleic acid molecule, wherein the double-stranded nucleic acid molecule is labeled with a fluorophore and a quencher and has at least one mutated nucleotide in either strand, and wherein the mutated nucleotide corresponds to the type of the nucleic-acid-repair enzyme; and a second part, comprising a S1 nuclease.

The detailed skill and part of the embodiment will be described hereafter. This provides the scope of the invention to those skilled in the art to understand the characteristic of the present invention.

### BRIEF DESCRIPTION OF THE DRAWINGS

FIG. 1 is a schematic diagram showing the mechanism of determining the enzyme activity by using a double-stranded nucleic acid molecule and S1 nuclease;

FIGS. 2A and 2B illustrate the curves of fluorescence signal showing the reactions of different concentrations of S1 nuclease and DNA molecule with an 8-oxoG mutation;

FIG. 3 is a curve of fluorescence signal showing the reaction of OGG1 and a DNA molecule with an 8-oxoG mutation under different pH conditions;

FIG. 4 is a Michaelis-Menten kinetic curve of OGG1 determined using a DNA molecule with an 8-oxoG mutation as the substrate;

FIG. 5 is a Michaelis-Mentent kinetic curve of UDG determined using a DNA molecule with a uridylic acid mutation as the substrate; and

FIG. 6 is a histogram showing the activities of OGG1 in the protein samples determined using OGG1, S1 nuclease and DNA molecule with 8-oxoG mutation.

### DETAILED DESCRIPTION

The following will describe some embodiments of the present invention in detail. However, without departing from the spirit of the present invention, the present invention may be embodied in various embodiments and should not be limited to the embodiments described in the specification. In addition, unless otherwise state herein, the expressions “a”, “the”, or the like that are recited in the specification of the present invention (especially in the claims) should include both the singular and plural forms. Furthermore, the term “subject” used in this specification refers to an animal (such as a mammalian), plant or microorganism. The term “nucleic acid” includes DNA (deoxyribonucleic acid) and RNA (ribonucleic acid). The term “double-stranded nucleic acid” refers to a nucleic acid has base paring in its structure, such as a double-stranded DNA, double-stranded RNA and a hairpin structure folded by a single-stranded DNA or single-stranded RNA.

As described above, nucleic acid damage is generated in the subject due to the exposures to ROS (i.e. oxidative stress), ultraviolet, radiated ray and/or chemical materials at any time. The incorrect pairing of nucleotide bases may also cause nucleic acid mutation such as the uridylic acid mismatch. In general, when a nucleic acid is damaged, a nucleic-acid-repair enzyme in the subject will be activated to remove the damaged nucleic acid. Therefore, if the activity of a nucleic-acid-repair enzyme decreased, the damaged nucleic acid cannot be repaired. As a result, the aging degree or disease occurrence will increase.

There are many kinds of nucleic-acid-repair enzymes. Different nucleic-acid-repair enzymes have different substrates (i.e. the mutated nucleic acid that can be repaired by the nucleic-acid-repair enzyme). Each of the nucleic-acid-repair enzymes can repair a specific type of nucleic acid damage. Some common nucleic-acid-repair enzymes and their correlative substrates are shown below.

TABLE 1

| Nucleic-acid-repair enzyme | Substrate |
|---|---|
| APE 1 (AP Endonuclease 1) | abasic site (apurinic/apyrimidinic |
| | site, AP site) |
| Endo III (Endonuclease III) | oxidative pyrimidine, abasic site |
| Endo IV (Endonuclease IV) | abasic site |
| Endo V (Endonuclease V) | deoxyinosine, mismatch |
| Endo VIII (Endonuclease VIII) | oxidative pyrimidine, abasic site |
| Fpg (formamido- pyrimidine- | oxidative pyrimidine, abasic site |
| DNA glycosylase) | |
| OGG1 (8-oxoguanine DNA | oxidative pyrimidine, abasic site |
| glycosylase 1) | |
| NEIL1 (Endonuclease VIII-like 1) | oxidative pyrimidine, oxidative |
| | purine, abasic site |
| T7 Endo I (T7 Endonuclease I) | Mismatch |
| T4 PDG (T4 pyrimidine dimer | pyrimidine dimer |
| DNA glycosylase) | |
| UDG (uracil DNA glycosylase) | uridylic acid |
| SMUG1 (Single-strand selective | uridylic acid (mismatch), 5-hydroxy |
| mono-functional uracil | uracil, 5-hydroxymethyl uracil |
| DNA glycosylase) | (HMU), 5-methyl acyl uracil |
| AAG (methylpurine DNA | deoxyinosine, alkylation purine |
| glycosylase) | |

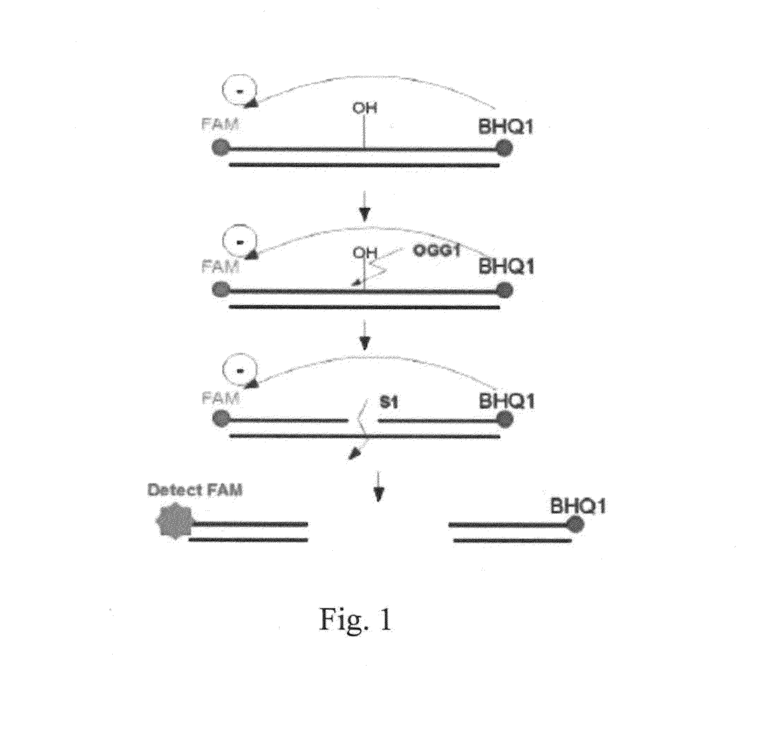

The inventors of the present invention developed a platform for determining the activity of nucleic-acid-repair enzyme by using a double nucleic acid molecule and S1 nuclease. FIG. 1 is a schematic diagram showing the mechanism of determining enzymes activity using the platform of the present invention. As exemplified by the embodiment of FIG. 1, in the platform for determining the activity of nucleic-acid-repair enzyme, a short double-stranded nucleic acid is designed first, wherein the nucleic acid has at least one mutated nucleotide (e.g., 8-oxoG) and the end of one strand in the double-stranded nucleic acid is labeled with a fluorophore (e.g.,6-carboxyfluorescein (6FAM)). The opposite end is labeled with a quencher (e.g., benzo(h)quinoline (BHQ1)). The quencher can inhibit the fluorescence signal of the fluorophore before the double-stranded nucleic acid is cut and separated. The labeled double-stranded nucleic acid and a sample comprising a nucleic-acid-repair enzyme (wherein the type of the nucleic-acid-repair enzyme corresponds to the mutated nucleotide in the nucleic acid, for example, OGG1, which can be used for repairing 8-oxoG) are mixed for reaction. The nucleic-acid-repair enzyme will recognize and remove the mutated nucleotide in the double-stranded nucleic acid and form a gap or an abasic site. Subsequently, the S1 nuclease is used for recognizing and digesting the double-stranded nucleic acid with a gap or abasic site. As a result, the fluorophore is separated from the quencher and a fluorescence signal is emitted. The activity of the nucleic-acid-repair enzyme can then be calculated by measuring the strength of the fluorescence signal.

Therefore, the present invention provides a method for determining the activity of a nucleic-acid-repair enzyme in a sample, comprising the following steps: (i) providing a double-stranded nucleic acid molecule, which is labeled with a fluorophore and a quencher and has at least one mutated nucleotide in either strand; (ii) mixing the double-stranded nucleic acid molecule, S1 nuclease, and the sample to obtain a mixture; and measuring the fluorescence intensity of the mixture.

In the method of the present invention, the mutated nucleotide corresponds to the type of the nucleic-acid-repair enzyme. For, example, if OGG1 (i.e. the DNA repair enzyme for repairing 8-oxoG) is the nucleic-acid-repair enzyme to be measured, the double-stranded nucleic acid molecule should have at least one 8-oxoG; if UDG (i.e. the DNA repair enzyme for uridylic acid) is the nucleic-acid-repair enzyme to be determined, the double-stranded nucleic acid molecule should have at least one uridylic acid in either strand.

The term “mutated nucleotide” used in the specification refers to a nucleotide with an abnormally modified base, a hydrolyzed base, an abnormal bonding between adjacent bases, a break in the bonding between bases, and/or a nucleotide mismatch. The examples of nucleotide with an abnormally modified base include, but are not limited to, 8-oxoguanine (8-oxoG) generated by the oxidation of a nucleotide base; O6-methylguanine, N7-methylguanine and/or N3-methyladenine generated by the alkylation of a nucleotide base. The examples of nucleotide with a hydrolyzed base include, but are not limited to, a depurinated or depyrimidinated nucleotide. The examples of a nucleotide with an abnormal bonding between adjacent bases include, but are not limited to, a dU:dA mismatch.

In the present invention, the types of nucleic-acid-repair enzyme are unlimited, as long as the nucleic-acid-repair enzyme can recognize the mutated nucleotide in a nucleic acid sequence. For example, suitable nucleic-acid-repair enzymes include, but are not limited to, APE 1 (AP Endonuclease 1), Endo III (Endonuclease III), Endo IV (Endonuclease IV), Endo V (Endonuclease V), Endo VIII (Endonuclease VIII), Fpg (formamido-pyrimidine-DNA glycosylase), OGG1 (8-oxoguanine DNA glycosylase 1), NEIL1 (Endonuclease VIII-like 1), T7 Endo I (T7 Endonuclease I), T4 PDG (T4 pyrimidine dimer DNA glycosylase), UDG (uracil DNA glycosylase), SMUG1 (Single-strand selective monofunctional uracil DNA glycosylase), AAG (methylpurine DNA glycosylase), etc. According to some embodiments in the present invention, the nucleic-acid-repair enzyme is OGG1 and/or UDG.

According to the method of the present invention, the sources of the double-stranded nucleic acid are unlimited. For example, the double-stranded nucleic acid can be an artificial nucleic acid or a natural biological material. In addition, the double-stranded molecule is labeled with at least one fluorophore and one quencher, wherein the fluorophore and the quencher are preferably labeled at the opposite ends in the same strand or at the opposite ends in different strands respectively. The quencher can inhibit the fluorescence signal of the fluorophore in the double-stranded nucleic acid molecule before the nicked double-stranded nucleic acid is cut by S1 nuclease. A fluorophore suitable for the present invention includes, but is not limited to, 6-carboxy-fluorescein (6FAM), 6-carboxy-tetrachlorofluorescein (TET), 6-carboxy-4′,5′-dichloro-2′, 7′ -dimethoxyfluorescein (JOE), 6-carboxy -hexachlorofluorescein (HEX), etc. A quencher suitable for the present invention includes, but is not limited to, benzo(h)quinoline (BHQ), 6- carboxy-tetramethylrhodamine (TAMRA), 4-(4-dimethylaminophenyl) diazenylbenzoic acid (DABCYL), etc. In an embodiment of the present invention, a 6FAM fluorophore is used for labeling the 5′ end of one strand of the double-stranded nucleic acid molecule, and a BHQ1 quencher is used for labeling the 3′ end of the same strand by using a commercially purchased Taq Man Probe system.

Furthermore, in order to inhibit the fluorescence signal of the fluorophore by the labeled quencher in the double-stranded nucleic acid which is not cut by S1 nuclease, the length of the double-stranded nucleic acid preferably ranges from about 10 base pairs to about 200 base pairs, and more preferably ranges from about 15 base pairs to about 50 base pairs. In some embodiments of the present invention, the length of the double-stranded nucleic acid ranges from between 20 base pairs to about 35 base pairs.

Any suitable steps without departing from the spirit of the present invention can be adopted to determine the activity of the nucleic-acid-repair enzyme using the double-stranded nucleic acid molecule of the present invention and S1 nuclease. For example, in an embodiment of the present invention, the activity of a nucleic-acid-repair enzyme can be determined by following step: (i) providing a double-stranded nucleic acid, wherein the double-stranded nucleic acid molecule is labeled with a fluorophore and a quencher and has at least one mutated nucleotide in either strand; (ii) mixing the double-stranded nucleic acid molecule, S1 nuclease, a buffer solution and a sample with a nucleic-acid-repair enzyme to obtain a mixture; and determining the fluorescence signal of the mixed solution by using, for example, a real-time quantitative polymerase chain reaction analyzer (q-PCR) or a fluorescence luminescence analyzer.

In the above step (i), the amount ratio of the double-stranded nucleic acid molecule and the S1 nuclease in the mixture is preferably about 0.25 enzyme units (U) to about 5 U of S1 nuclease per 100 nM double-stranded nucleic acid molecule to make the nucleic-acid-repair enzyme successfully recognize the mutated nucleotide and to avoid the non-specific reaction of S1 nuclease. It is preferred that the amount ratio is 0.5 U to about 2.5 U S1 nuclease per 100 nM double-stranded nucleic acid molecules.

The sample with nucleic-acid-repair enzyme can be extracted from the blood, urine, saliva, tissue, etc. In addition, the sample can be optionally subjected to a protein extraction step to increase the concentration of nucleic-acid-repair enzyme in the sample, In the case of using a protein as a sample, the amount of the protein sample in the mixture is preferably 0.1 nM to 20 nM, and more preferably is 0.2 nM to 5 nM. The buffer solution preferably comprises sodium chloride, tris(hydroxymethyl)aminomethane-hydrogen chloride (Tris-HCl), magnesium chloride and/or dithiothreitol. The pH of the buffer solution preferably ranges from 6.0 to about 8.5.

The present invention also provides a kit for determining the activity of a nucleic-acid-repair enzyme, comprising the following: a first part, comprising a double-stranded nucleic acid molecule, wherein the double-stranded nucleic acid molecule is labeled with a fluorophore and a quencher and has at least one mutated nucleotide in either strand, and wherein the mutated nucleotide corresponds to the type of the nucleic-acid-repair enzyme; and a second part, comprising S1 nuclease. The properties and characteristics and preferable amounts of using the nucleic-acid-repair enzyme, double-stranded nucleic acid molecule, fluorophore, quencher, mutated nucleotide and S1 nuclease are all as described above.

The kit of the present invention can further comprise a third part, wherein the third part comprises a buffer solution. The buffer solution preferably comprises sodium chloride, Tris-HCl, magnesium chloride and/or dithiothreitol. The buffer solution preferably has a pH value ranging from about 6.0 to about 8.5. In addition, the kit can comprise another component, as long as the component has no adverse influence on the analysis.

The present invention will be further illustrated in details with specific examples as follows. However, the examples hereafter are provided only for illustrating the present invention. The scope of the present invention is not limited thereby. The scope of the present invention is illustrated in the claim thereafter.

### EXAMPLES

### Preparation Example 1

### The Preparation of a Double-Stranded Nucleic Acid Molecule with 8-oxoG

A single-stranded DNA sequence: 5′-CATCGTTGTC[8-oxoG]CAGACCTGGTGGAT-3′ (SEQ ID NO: 1) was synthesized , wherein the [8-oxoG] was 8-oxoguanine. A single-strand DNA sequence complementary to SEQ ID NO: 1: 5′-CGGTATCCACCAGGTCTGCGACAACGATGAAGCC-3′ (SEQ ID NO: 2) was synthesized. A fluorophore 6FAM was labeled at the 5′ end of SEQ ID NO: 1 and a quencher BHQ1 was labeled at the 3′ end of SEQ ID NO: 1 by using a Taq Man Probe system. Subsequently, to make these two single-stranded DNA anneal to form a double-stranded DNA molecule, 400 nM of SEQ ID NO:1 which was labeled with 6FAM and BHQ1 and 800 nM of SEQ ID NO: 2 were mixed for reaction in a PCR machine (Eppendorf, Germany) at the following conditions: 95° C., 5 minutes for 1 cycle; 95° C. (decreasing by 5° C. per cycle), 1 minute for 7 cycles; 60° C., 30 minutes for 1 cycle; 60° C. (decreasing by 1° C. per cycle), 1 minute for 35 cycles. Then, a double-stranded DNA molecule with a mutated nucleotide, 8-oxoG, and labeled with the fluorophore and quencher could be obtained.

### Preparation example 2

### The preparation for a Double-Stranded Nucleic Acid Molecule with Uridylic Acid

A single-stranded DNA sequence: 5′-AGTCAGTCGAGCUCATTCAGT-3′ (SEQ ID NO: 3) was synthesized, wherein the “U” represents a uridylic acid. A single-strand DNA sequence: 5′- ACTGACTGAATGAGCTCGACTGACT-3′ (SEQ ID NO: 4) complementary to SEQ ID NO: 3 was synthesized. A fluorophore 6FAM was labeled at the 5′ end of SEQ ID NO: 3 and a quencher BHQ1 was labeled at the 3′ end of SEA ID NO: 3 by using a Taq Man Probe system. Subsequently, to make these two single-stranded DNA anneal to form a double-stranded DNA molecule, 400 of nM SEQ ID NO: 3 which was labeled with 6FAM and BHQ1 and 800 nM of SEQ ID NO: 4 were mixed for reaction in a PCR machine at the following conditions: 95° C., 5 minutes for 1 cycle; 95° C. (decreasing by 5° Cper cycle), 1 minute for 7 cycles; 60° C., 30 minutes for 1 cycle; 60° C. (decreasing by 1° C. per cycle), 1 minute for 35 cycles. Then, a double-stranded DNA molecule with a mutated nucleotide, uridylic acid, and labeled with the fluorophore and quencher could be obtained.

### Example 1

### Determination of the Amount of S1 Nuclease Required for Determining the Activity of a Nucleic-Acid-Repair Enzyme

It has been known that an appropriate amount of S1 nuclease could be used to cut a single-stranded nucleic acid and a double-stranded nucleic acid at the site of the gap or abasic site. However, an excessive amount of S1 nuclease will cause S1 nuclease to erroneously cut a double-stranded nucleic acid. This example discussed the appropriate amount of S1 nuclease for determining the activity of a nucleic-acid-repair enzyme when using the double-stranded DNA molecule prepared in the Preparation Example 1.

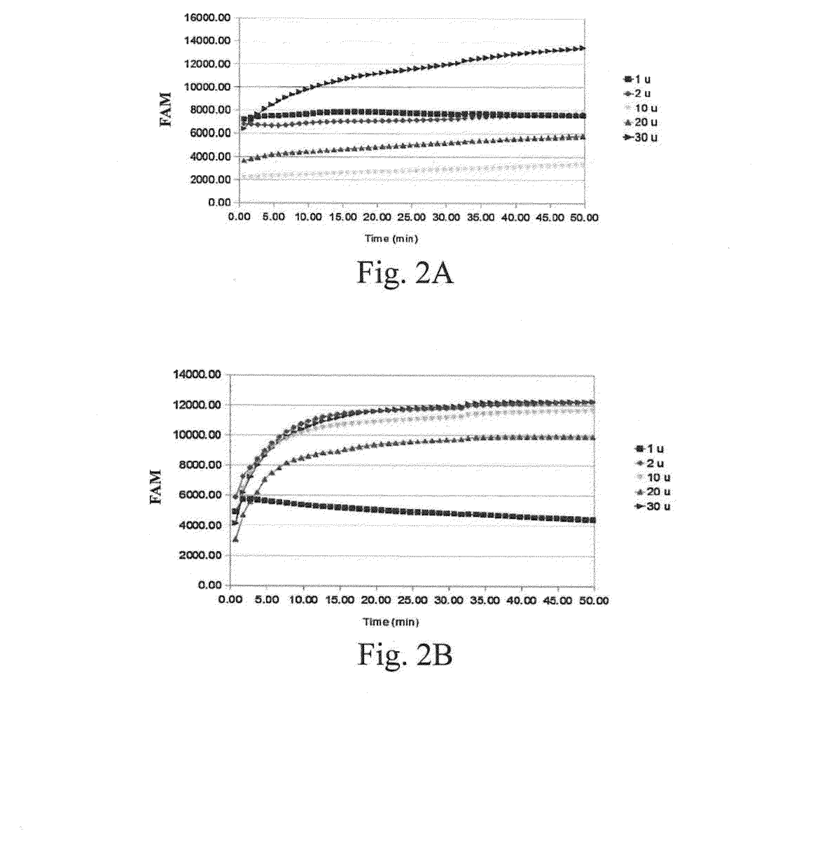

Four hundred nM of the double-stranded DNA molecule with 8-oxoG prepared in the Preparation Example 1 and S1 nuclease (1 U, 2 U, 10 U, 20 U, or 30 U) were mixed. The fluorescence signals were measured in the case of with or without 1 U of OGG1, by using an iQ5 real-time qPCR analyzer (BioRad, USA) or an MRX fluorescence luminescence analyzer (Eppendorf, Germany) (37° C., 15 seconds every minute, 50 cycles). The results are shown in FIGS. 2A (without OGG1) and 2B (with OGG1).

As shown in FIG. 2A, S1 nuclease of a concentration greater than 20 U would react with the double-stranded nucleic acid in the case that the OGG1 was absent. As shown in FIG. 2B, S1 nuclease of a concentration greater than 1 U would react with the nucleic acid with a gap in the case that the OGG1 was existed and the concentration of the double-stranded nucleic acid was 400 nM. According to the above experimental results, when a double-stranded DNA molecule prepared in the Preparation Example 1 is used to determine the activity of a nucleic-acid-repair enzyme, the amount of S1 nuclease preferably ranges between 1 U to 20 U, and more preferably, between 2 U to 10 U in the case that the concentration of the double-stranded nucleic acid molecule was 400 nM. That was, the amount of double-stranded nucleic acid molecule and S1 nuclease preferably ranges between 0.25 U to 5 U S1 nuclease per 100 nM of the double-stranded nucleic acid molecule, and more preferably, between 0.5 U to 2.5 U S1 nuclease per 100 nM of the double-stranded nucleic acid molecule.

### Example 2

### Measurement of the Appropriate pH Value for Determining the Activity of a Nucleic-Acid-Repair Enzyme

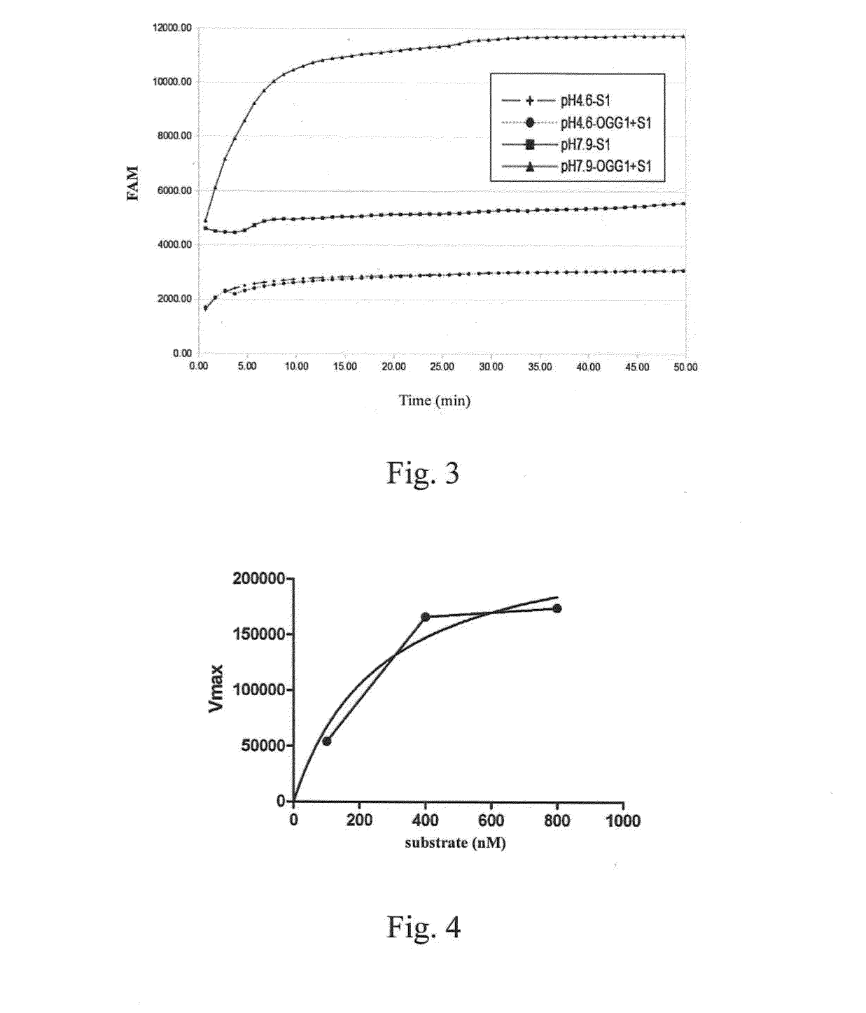

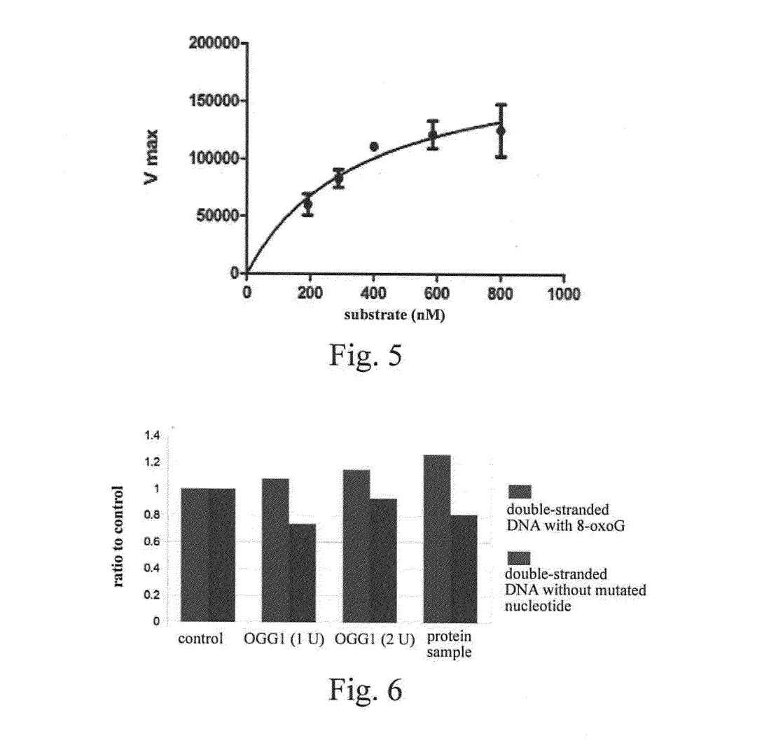

This example discussed the effect of pH value for determining the activity of a nucleic-acid-repair enzyme using the double-stranded DNA molecule prepared in the Preparation Example 1. Four hundred nM of the double-stranded DNA molecule with 8-oxoG prepared in the Preparation Example 1 was mixed with 4 U S1 nuclease. The reactions are conducted in a case with or without 1 U OGG1 and under a pH value of 4.6 or 7.9 respectively. The fluorescence signals were measured by using an iQ5 real-time q-PCR analyzer or an MRX fluorescence luminescence analyzer (37° C., 15 seconds every minute, 50 cycles). The result is shown in FIG. 3.

As shown in FIG. 3, when the reaction pH value was 4.6, the fluorescence signal appeared whether the OGG1 was added or not, indicating that the reaction was non-specific; however, when the reaction pH value was 7.9, the fluorescence signal appeared only as the OGG1 was added. The experimental results showed that the specificity of this assay is not enough at pH 4.6 and that the preferable pH value for the reaction was 7.9.

### Example 3

### The Analysis of the Activity of a Nucleic-Acid-Repair Enzyme

(1) Preparation of the Sample

8 ml human blood was extracted by a vacutainer comprising an anticoagulant (citrate-phosphate-dextrose-adenine, CPDA-1) and mixed with a balance buffer in the proportion ratio of 1:1. The blood was mixed with a Ficoll-Paque PLUS solution (monocyte parting liquid, GE, USA) in the proportion ratio of 3:2.4. First, a Ficoll-Paque PLUS solution was added in a 50 ml tube, and subsequently, the blood was carefully added along the wall of the tube and centrifuged for 40 minutes (100 g, 18° C.) to remove the supernatant. The lymphocytes pellet was transferred to a new tube. Three times the volume of a balance solution was added and mixed uniformly and centrifuged for 10 minutes (100 g, 18° C.) to remove the supernatant. Six (6) to eight (8) ml of a balance buffer was added. The centrifugation and the removal of supernatant were repeated. Subsequently, the supernatant was removed after PBS washing, and then, 5 ml of a buffer solution (comprising 155 mM NH4Cl, 0.01 M KHCO3, 0.1 mM EDTA) was added and centrifuged for 4 minutes to remove the supernatant. The cells were stained by a 0.4% Trypan blue buffer (Sigma, USA). The cell number was counted. The cells were dissolved at a concentration of 20,000 cells/ml by adding 50 mM tris-HCl, 1 mM EDTA, 0.5 mM DTT, 0.5 mM spermidine, 0.1 mM spermine and 1% protease inhibitor cocktail. Subsequently, 220 mM KCl was added and left at 30° C. for 30 minutes to extract the proteins of the lymphocytes

(2) Analysis of the Activity of OGG1 Enzyme

For the experimental group, the protein sample comprising OGG1 according to the above (1) was extracted and mixed with a 10X buffer solution (500 mM NaC1, 100 mM Tris-Hcl, 100 mM MgC12, 10 mM DTT, ph 7.9) and a 200 nM double-stranded DNA with 8-oxoG mutated nucleotide prepared in Preparation Example 1 or the double-stranded DNA without a mutated nucleotide and 1 U S1 nuclease (Promega, America). The above extraction step proceeded on ice and in the dark.

For the control group, OGG1 was extracted with different concentrations (0 U (control), 1 U or 2 U)) and mixed with a 10× buffer solution and a 200 nM double-stranded DNA with 8-oxoG mutated nucleotide prepared in Preparation Example 1 or the double-stranded DNA without a mutated nucleotide and 1 U Si nuclease. Subsequently, the fluorescence signal was determined by using an iQ5 real-time q-PCR analyzer or an MRX fluorescence luminescence analyzer (37° C., 15 seconds every minute, 40 cycles). The result is shown in FIG. 6.

As shown in FIG. 6, the determining method that use the double-stranded DNA with the 8-oxoG mutated nucleotide and S1 nuclease could be used for determining the enzyme activity of OGG1 in the protein sample extracted from lymphocyte. According to the data of the control group, the activity of OGG1 enzyme in the protein sample of this example was calculated to be about 4.58 U.

According to the above results, the double-stranded nucleic acid molecule and S1 nuclease can be used for determining the activity of a nucleic-acid-repair enzyme and the km value of the enzyme.

The above examples are used to illustrate the principle and efficacy of the present invention but are not used to limit to the present invention. People skilled in this field may proceed with a variety of modifications and replacements based on the disclosures and suggestions of the invention as described without departing from the technical principle and spirit thereof Therefore, the scope of protection of the present invention is that as defined in the claims as appended.

What is claimed is:

1. A method for determining the activity of a nucleic-acid-repair enzyme in a sample, comprising the following steps:
providing a double-stranded nucleic acid molecule, which is labeled with a fluorophore and a quencher and has at least one mutated nucleotide in either strand;
(ii) mixing the double-stranded nucleic acid molecule, S1 nuclease, and the sample to obtain a mixture; and measuring the fluorescence intensity of the mixture.

2. The method according to claim 1, wherein the nucleic-acid-repair enzyme is selected from the group consisting of APE 1 (AP Endonuclease 1), Endo III (Endonuclease III), Endo IV (Endonuclease IV), Endo V (Endonuclease V), Endo VIII (Endonuclease VIII), Fpg (formamido-pyrimidine-DNA glycosylase), OGG1 (8-oxoguanine DNA glycosylase 1), NEIL1 (Endonuclease VIII-like 1), T7 Endo I (T7 Endonuclease I), T4 PDG (T4 pyrimidine dimer DNA glycosylase), UDG (uracil DNA glycosylase), SMUG1 (Single-strand selective monofunctional uracil DNA glycosylase), AAG (methylpurine DNA glycosylase), and combinations thereof.

3. The method according to claim 1, wherein the nucleotide mutation is 8-oxoG (8-oxoguanine) and the nucleic-acid-repair enzyme is OGG1 (8-oxoguanine DNA glycosylase 1).

4. The method according to claim 1, wherein the mutated nucleotide is uridylic acid, and the nucleic-acid-repair enzyme is UDG (uracil DNA glycosylase).

5. The method according to claim 1, wherein the double-stranded nucleic acid molecule is of a length ranging from about 10 base pairs to about 200 base pairs.

6. The method according to claim 5, wherein the length of the double-stranded nucleic acid molecule is about 15 base pairs to about 50 base pairs.

7. The method according to claim 1, wherein the double-stranded nucleic acid molecule is labeled with the fluorophore and the quencher respectively at the opposite ends in the same strand or at the opposite ends in different strands.

8. The method according to claim 1, wherein in step (i), the double-stranded nucleic acid molecule and S1 nuclease are mixed at a ratio of about 0.25 enzyme units (U) to about 5 enzyme units S1 nuclease per 100 nM of the double-stranded nucleic acid molecule.

9. The method according to claim 1, wherein in step (i), the double-stranded nucleic acid molecule and S1 nuclease are mixed at a ratio of about 0.5 enzyme units (U) to about 2.5 enzyme units S1 nuclease per 100 nM of the double-stranded nucleic acid molecule.

10. The method according to claim 8, wherein in step (i), about 1 enzyme units to about 20 enzyme units of S1 nuclease are used.

11. The method according to claim 10, wherein about 2 enzyme units to about 10 enzyme units of S1 nuclease are used.

12. A kit for determining the activity of a nucleic-acid-repair enzyme, comprising:
a first part, comprising a double-stranded nucleic acid molecule, wherein the double-stranded nucleic acid molecule is labeled with a fluorophore and a quencher and has at least one mutated nucleotide in either strand, and wherein the mutated nucleotide corresponds to the type of the nucleic-acid-repair enzyme; and a second part, comprising Si nuclease.

13. The kit according to claim 12, further comprising a third part, wherein the third part comprises a buffer solution.

14. The kit according to claim 13, wherein the buffer solution comprises sodium chloride, Tris-hydrochloric acid, magnesium chloride and dithiothreitol, and wherein the buffer solution is of a pH value ranging from about 6.0 to about 8.5.

15. The kit according to claim 12, wherein the double-stranded nucleic acid molecule is of a length ranging from about 10 base pairs to about 200 base pairs.

16. The kit according to claim 15, wherein the length of the double-stranded nucleic acid molecule is about 15 base pairs to about 50 base pairs.

17. The kit according to claim 12, wherein the double-stranded nucleic acid molecule is labeled the fluorophore and the quencher respectively at the opposite ends in the same strand or at the opposite ends in different strands.

18. The kit according to claim 12, wherein the nucleic-acid-repair enzyme is selected from the group consisting of APE 1 (AP Endonuclease 1), Endo III (Endonuclease III), Endo IV (Endonuclease IV), Endo V (Endonuclease V), Endo VIII (Endonuclease VIII), Fpg (formamido-pyrimidine-DNA glycosylase), OGG1 (8-oxoguanine DNA glycosylase 1), NEIL1 (Endonuclease VIII-like 1), T7 Endo I (T7 Endonuclease I), T4 PDG (T4 pyrimidine dimer DNA glycosylase), UDG (uracil DNA glycosylase), SMUG1 (Single-strand selective monofunctional uracil DNA glycosylase), AAG (methylpurine DNA glycosylase), and combinations thereof

19. The kit according to claim 12, wherein the mutated nucleotide is 8-oxoG (8-oxoguanine) and the kit is used for determining the activity of OGG1 (8-oxoguanine DNA glycosylase 1).

20. The kit according to claim 12, wherein the mutated nucleotide is uridylic acid, and the kit is used for determining the activity of UDG (uracil DNA glycosylase).


SEQUENCE LISTING (4 sequences)

SEQ ID NO: 1 - DNA, 25 bp, Artificial sequence
  single strande DNA sequence with an  8-oxoG nucleotide
catcgttgtcncagacctggtggat

SEQ ID NO: 2 - DNA, 34 bp, Artificial sequence
  single strand DNA sequence complementary to SEQ ID NO 1
cggtatccaccaggtctgcgacaacgatgaagcc

SEQ ID NO: 3 - DNA, 21 bp, Artificial sequence
  single strand DNA with a uracil nucleotide
agtcagtcgagcncattcagt

SEQ ID NO: 4 - DNA, 25 bp, Artificial sequence
  single strand DNA sequence complementary to SEQ ID NO 3
actgactgaatgagctcgactgact